(19) United States
(12) Patent Application Publication
(10) Pub. No.: US 2026/0110404 A1
(43) Pub. Date: Apr. 23, 2026

(54) HYDROGEN GAS STORAGE DEVICE

(71) Applicant: TOYOTA JIDOSHA KABUSHIKI KAISHA, Toyota-shi (JP)

(72) Inventor: Mikio YASUNAGA, Nagoya-shi (JP)

(73) Assignee: TOYOTA JIDOSHA KABUSHIKI KAISHA, Toyota-shi (JP)

(21) Appl. No.: 19/266,641

(22) Filed: Jul. 11, 2025

(30) Foreign Application Priority Data
Oct. 22, 2024 (JP) 2024-185985

(51) Int. Cl. F17C 13/04

(52) U.S. Cl. CPC F17C 13/04; F17C 2205/013; F17C 2221/012; F17C 2250/0439; F17C 2250/0636

(57) ABSTRACT

A hydrogen gas storage device includes a plurality of hydrogen tanks in which opening and closing valves are provided in a discharge flow path, a hydrogen gas supply flow path that is connected to the hydrogen tanks through a plurality of the opening and closing valves and supplies hydrogen gas from the hydrogen tanks to an external hydrogen gas supply destination, a plurality of temperature sensors that detect temperatures of corresponding hydrogen tanks, and a control device. The control device opens a part of the hydrogen tanks among the hydrogen tanks in a hydrogen gas supply operation. The control device closes the hydrogen tank of which the temperature is equal to or lower than the reference value when the temperature of the hydrogen tank in the open state is equal to or lower than the reference value, and opens at least one of the hydrogen tanks in the closed state.

### CROSS-REFERENCE TO RELATED APPLICATION

This application claims priority to Japanese Patent Application No. 2024-185985 filed on Oct. 22, 2024. The disclosure of the above-identified application, including the specification, drawings, and claims, is incorporated by reference herein in its entirety.

### BACKGROUND

### 1. Technical Field

The technology disclosed in the present specification relates to a hydrogen gas storage device.

### 2. Description of Related Art

The hydrogen gas storage device disclosed in Japanese Unexamined Patent Application Publication No. 2015-132350 (JP 2015-132350 A) has a plurality of hydrogen tanks and a hydrogen gas supply flow path connected to the hydrogen tanks. The hydrogen gas supply flow path supplies hydrogen gas supplied from the hydrogen tanks to a hydrogen gas supply destination.

### SUMMARY

When the hydrogen gas is continuously supplied from the hydrogen tank to the hydrogen gas supply destination, the temperature of the hydrogen tank decreases. When the temperature of the hydrogen tank becomes low, the component of the hydrogen tank deteriorates. The present specification proposes a technique for supplying hydrogen gas to the hydrogen gas supply destination in a hydrogen gas storage device having a plurality of hydrogen tanks while suppressing a decrease in temperature of each hydrogen tank.

### Aspect 1

A hydrogen gas storage device disclosed in the present specification includes
a plurality of hydrogen tanks provided with opening and closing valves in discharge flow paths,
a hydrogen gas supply flow path connected to the hydrogen tanks through a plurality of the opening and closing valves, the hydrogen gas supply flow path being configured to supply hydrogen gas from the hydrogen tanks to an external hydrogen gas supply destination, a plurality of temperature sensors configured to detect temperatures of the respective hydrogen tanks, and
a control device.

The control device is configured to, in a hydrogen gas supply operation of supplying hydrogen gas to the hydrogen gas supply destination, control each of the opening and closing valves such that
a hydrogen tank among the hydrogen tanks is opened.

In addition, when a temperature of the hydrogen tank in an open state is equal to or lower than a reference value, the hydrogen tank of which the temperature is equal to or lower than the reference value is closed, and at least one of the hydrogen tanks in a closed state is opened.

In the hydrogen gas storage device described above,
in the hydrogen gas supply operation, when the temperature of the hydrogen tank in the open state is equal to or lower than the reference value, the control device closes the hydrogen tank of which the temperature is equal to or lower than the reference value to suppress the temperature decrease of the hydrogen tank. In addition, in this case, the control device opens at least one hydrogen tank in the closed state. Therefore, the supply of the hydrogen gas to the hydrogen gas supply destination can be continued.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a hydrogen gas supply system;

FIG. 2 is a flowchart of a hydrogen gas supply operation;

FIG. 3 is an explanatory diagram of a situation in which the hydrogen gas is supplied to the hydrogen gas supply destination; and

FIG. 4 is an explanatory diagram of a situation in which the hydrogen gas is supplied to the hydrogen gas supply destination.

### DETAILED DESCRIPTION OF EMBODIMENTS

### Aspect 2

Subsequently, additional configurations of the hydrogen gas storage device disclosed in the present specification will be described below in addition to the above aspect 1.

The hydrogen gas storage device according to aspect 1, the control device is configured to, when the temperature of the hydrogen tank in the open state is equal to or lower than the reference value, open at least one hydrogen tank among the hydrogen tanks in the closed state having the temperature higher than the reference value.

According to an aspect 2, the temperature in the hydrogen tank is in the low temperature state, so that the deterioration of the component of the hydrogen tank can be suppressed.

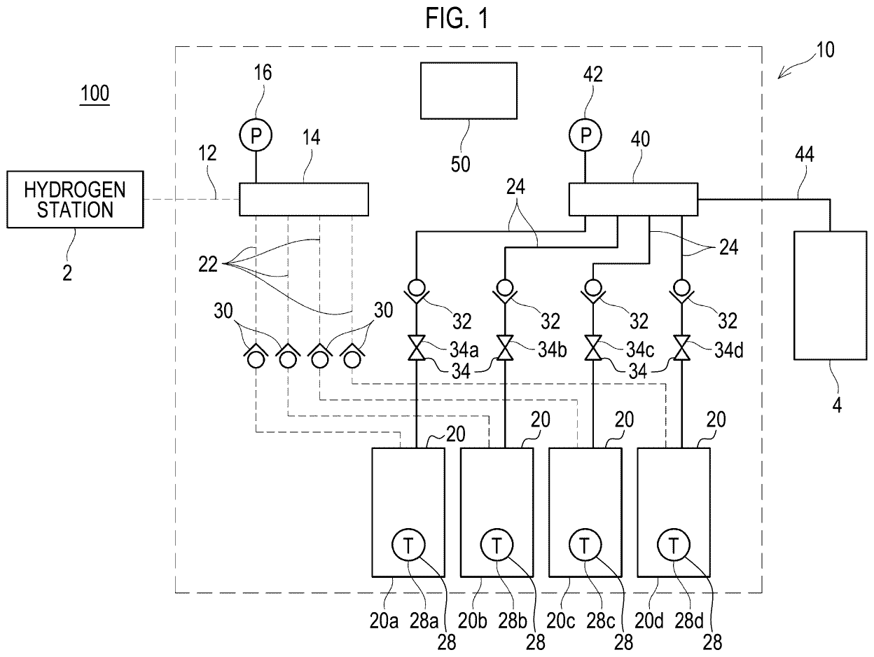

A hydrogen gas supply system 100 shown in FIG. 1 has a hydrogen station 2, a hydrogen gas storage device 10, and a hydrogen gas supply destination 4. The hydrogen station 2 supplies the hydrogen gas to the hydrogen gas storage device 10. The hydrogen gas storage device 10 stores the hydrogen gas supplied from the hydrogen station 2. In addition, the hydrogen gas storage device 10 supplies the hydrogen gas to the hydrogen gas supply destination 4. The hydrogen gas supply destination 4 is a device that consumes hydrogen gas. For example, the hydrogen gas supply destination 4 is a device (for example, a fuel cell electric vehicle) that uses a fuel cell as a power source.

The hydrogen gas storage device 10 has a plurality of hydrogen tanks 20. Each hydrogen tank 20 stores hydrogen gas therein.

The hydrogen gas storage device 10 has a hydrogen gas filling flow path 12, a hydrogen gas filling flow path connection portion 14, and a plurality of hydrogen gas inflow flow paths 22. An upstream end of the hydrogen gas filling flow path 12 is connected to the hydrogen station 2. A downstream end of the hydrogen gas filling flow path 12 is connected to a hydrogen gas filling flow path connection portion 14. An upstream end of each hydrogen gas inflow flow path 22 is connected to the hydrogen gas filling flow path connection portion 14. A downstream end of each hydrogen gas inflow flow path 22 is connected to the corresponding hydrogen tank 20. The hydrogen gas discharged from the hydrogen station 2 is supplied to each of the hydrogen gas inflow flow paths 22 through the hydrogen gas filling flow path 12 and the hydrogen gas filling flow path connection portion 14. The hydrogen gas passing through each hydrogen gas inflow flow path 22 is supplied to the hydrogen tank 20. A check valve 30 is provided in each of the hydrogen gas inflow flow paths 22. The check valve 30 prevents hydrogen gas from flowing from the hydrogen tank 20 to the hydrogen gas filling flow path connection portion 14.

A hydrogen gas pressure sensor 16 is provided in the hydrogen gas filling flow path connection portion 14. The hydrogen gas pressure sensor 16 detects the pressure of the hydrogen gas flowing in the hydrogen gas filling flow path connection portion 14.

The hydrogen gas storage device 10 has a plurality of hydrogen gas discharge flow paths 24, a hydrogen gas supply flow path connection portion 40, and a hydrogen gas supply flow path 44. An upstream end of each hydrogen gas discharge flow path 24 is connected to the corresponding hydrogen tank 20. A downstream end of each hydrogen gas discharge flow path 24 is connected to a hydrogen gas supply flow path connection portion 40. An upstream end of the hydrogen gas supply flow path 44 is connected to the hydrogen gas supply flow path connection portion 40. A downstream end of the hydrogen gas supply flow path 44 is connected to the hydrogen gas supply destination 4. A check valve 32 and an opening and closing valve 34 are provided in each of the hydrogen gas discharge flow paths 24. The check valve 32 prevents the hydrogen gas from flowing from the hydrogen gas supply flow path connection portion 40 toward the hydrogen tank 20. The opening and closing valve 34 is a hydrogen gas discharge flow path 24 and is provided between the check valve 32 and the hydrogen tank 20. The opening and closing valve 34 is an electromagnetic valve and opens and closes the hydrogen gas discharge flow path 24.

When each of the opening and closing valves 34 is opened, hydrogen gas flows from the corresponding hydrogen tank 20 to the hydrogen gas discharge flow path 24. The hydrogen gas passing through the hydrogen gas discharge flow path 24 flows to the hydrogen gas supply destination 4 through the hydrogen gas supply flow path connection portion 40 and the hydrogen gas supply flow path 44.

A hydrogen gas pressure sensor 42 is provided in the hydrogen gas supply flow path connection portion 40. The hydrogen gas pressure sensor 42 detects the pressure of the hydrogen gas flowing from each hydrogen gas discharge flow path 24 to the hydrogen gas supply flow path connection portion 40.

The hydrogen gas storage device 10 has a plurality of temperature sensors 28. Each of the temperature sensors 28 is provided in each of the hydrogen tanks 20. The temperature sensor 28 detects the temperature of the corresponding hydrogen tank 20 (more specifically, the temperature of the hydrogen gas in the hydrogen tank 20). In addition, in the following, the hydrogen tanks 20 are referred to as hydrogen tanks 20a, 20b, 20c, 20d in order from the left side to the right side. Further, the opening and closing valves 34 provided in the hydrogen tanks 20a, 20b, 20c, 20d are referred to as opening and closing valves 34a, 34b, 34c, 34d. Further, the temperature sensor 28 that detects the temperature of the hydrogen tanks 20a, 20b, 20c, 20d is referred to as a temperature sensor 28a, 28b, 28c, 28d.

The hydrogen gas storage device 10 has a control device 50. The control device 50 controls the opening and closing valve 34 based on the temperature of each hydrogen tank 20.

As described above, the hydrogen gas supplied from the hydrogen station 2 is stored in each hydrogen tank 20. The hydrogen gas stored in each hydrogen tank 20 is supplied to the hydrogen gas supply destination 4 through the hydrogen gas supply flow path 44.

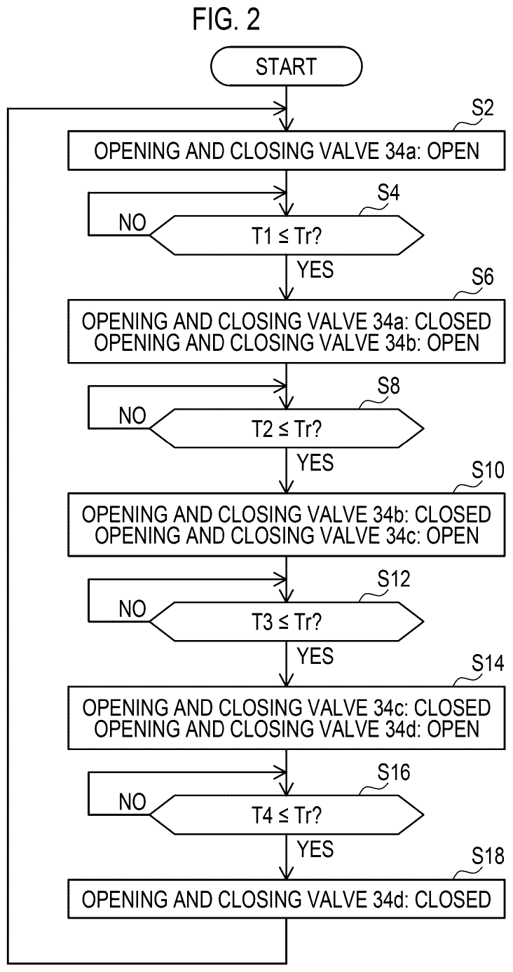

When the hydrogen gas is not supplied from each hydrogen tank 20 to the hydrogen gas supply destination 4, the control device 50 sets the opening and closing valves 34a to 34d to the closed state. Thereafter, when the hydrogen gas is supplied to the hydrogen gas supply destination 4, the control device 50 executes the hydrogen gas supply operation of FIG. 2.

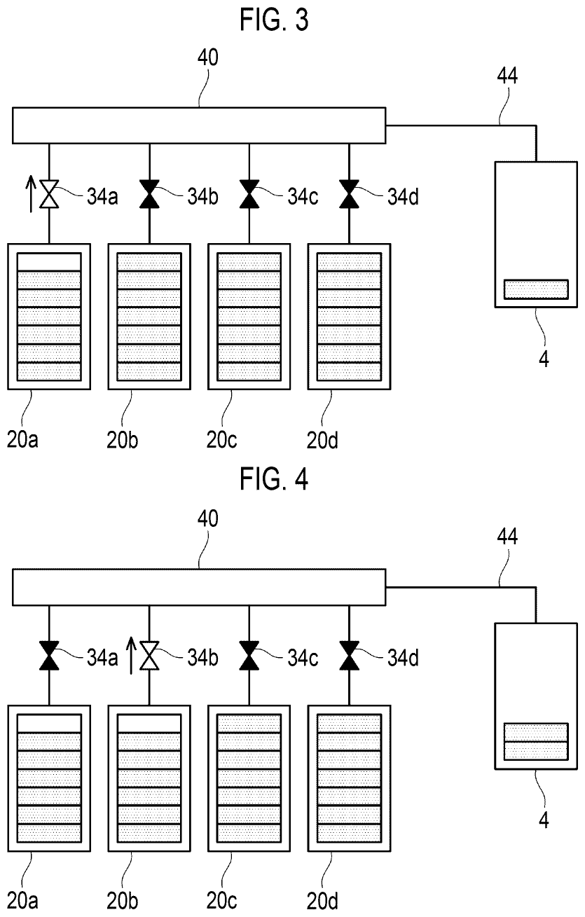

In S2, the control device 50 opens the opening and closing valve 34a. At this time, the opening and closing valves 34b, 34c, 34d are in the closed state. FIG. 3 shows a situation of the hydrogen gas supply operation in S2. In FIG. 3, the white opening and closing valve 34a is in an open state, and the black opening and closing valves 34b, 34c, 34d are in a closed state. Therefore, hydrogen gas is supplied from the hydrogen tank 20a to the hydrogen gas supply destination 4.

In S4, the control device 50 determines whether or not the temperature T1 of the hydrogen tank 20a detected by the temperature sensor 28a is equal to or lower than a reference value Tr (for example, −40° C.).

When the temperature T1 of the hydrogen tank 20a is higher than the reference value Tr (NO in S4), the control device 50 keeps the opening and closing valve 34a in the open state. Therefore, while the temperature T1 is higher than the reference value Tr, the opening and closing valve 34a is maintained in the open state, and the hydrogen gas is continuously supplied from the hydrogen tank 20a to the hydrogen gas supply destination 4. While the hydrogen gas is being supplied from the hydrogen tank 20a to the hydrogen gas supply destination 4, the temperature of the hydrogen tank 20a gradually decreases. When the temperature T1 of the hydrogen tank 20a decreases to or below the reference value Tr (YES in S4), the control device 50 executes S6.

In S6, the control device 50 closes the opening and closing valve 34a and opens the opening and closing valve 34b as shown in FIG. 4. In FIG. 4, the white opening and closing valve 34b is in an open state, and the black opening and closing valves 34a, 34c, 34d are in a closed state. In S6, the control device 50 opens the opening and closing valve 34b and closes the opening and closing valves 34a, 34c, 34d. Therefore, the supply of the hydrogen gas from the hydrogen tank 20a to the hydrogen gas supply destination 4 is stopped, and the hydrogen gas is supplied from the hydrogen tank 20b to the hydrogen gas supply destination 4. The supply of the hydrogen gas from the hydrogen tank 20a to the hydrogen gas supply destination 4 is stopped, so that the temperature decrease of the hydrogen tank 20a is stopped. As a result, the hydrogen tank 20a is prevented from being excessively cooled. In addition, since the supply of the hydrogen gas from the hydrogen tank 20b to the hydrogen gas supply destination 4 is started, the hydrogen gas can be continuously supplied to the hydrogen gas supply destination 4 without interruption.

In S8, the control device 50 determines whether or not the temperature T2 of the hydrogen tank 20b detected by the temperature sensor 28b is equal to or lower than the reference value Tr.

When the temperature T2 of the hydrogen tank 20b is higher than the reference value Tr (in a case of NO in S8), the control device 50 keeps the opening and closing valve 34b in the open state. Therefore, while the temperature T2 is higher than the reference value Tr, the opening and closing valve 34b is maintained in the open state, and the hydrogen gas is continuously supplied from the hydrogen tank 20b to the hydrogen gas supply destination 4. While the hydrogen gas is being supplied from the hydrogen tank 20b to the hydrogen gas supply destination 4, the temperature of the hydrogen tank 20b gradually decreases. When the temperature T2 of the hydrogen tank 20b decreases to or below the reference value Tr (YES in S8), the control device 50 executes S10.

In S10, the control device 50 closes the opening and closing valve 34b and opens the opening and closing valve 34c. That is, the control device 50 opens the opening and closing valve 34c and closes the opening and closing valves 34a, 34b, 34d. Therefore, the supply of the hydrogen gas from the hydrogen tank 20b to the hydrogen gas supply destination 4 is stopped, and the hydrogen gas is supplied from the hydrogen tank 20c to the hydrogen gas supply destination 4.

In S12, the control device 50 determines whether or not the temperature T3 of the hydrogen tank 20c detected by the temperature sensor 28c is equal to or lower than the reference value Tr.

When the temperature T3 of the hydrogen tank 20c is higher than the reference value Tr (NO in S12), the control device 50 keeps the opening and closing valve 34c in the open state. Therefore, while the temperature T3 is higher than the reference value Tr, the opening and closing valve 34c is maintained in the open state, and the hydrogen gas is continuously supplied from the hydrogen tank 20c to the hydrogen gas supply destination 4. While the hydrogen gas is being supplied from the hydrogen tank 20c to the hydrogen gas supply destination 4, the temperature of the hydrogen tank 20c gradually decreases. When the temperature T3 of the hydrogen tank 20c decreases to the reference value Tr or lower (YES in S12), the control device 50 executes S14.

In S14, the control device 50 closes the opening and closing valve 34c and opens the opening and closing valve 34d. That is, the control device 50 opens the opening and closing valve 34d and closes the opening and closing valves 34a, 34b, 34c. Therefore, the supply of the hydrogen gas from the hydrogen tank 20c to the hydrogen gas supply destination 4 is stopped, and the hydrogen gas is supplied from the hydrogen tank 20d to the hydrogen gas supply destination 4.

In S16, the control device 50 determines whether or not the temperature T4 of the hydrogen tank 20d detected by the temperature sensor 28d is equal to or lower than the reference value Tr.

When the temperature T4 of the hydrogen tank 20d is higher than the reference value Tr (NO in S16), the control device 50 keeps the opening and closing valve 34d in the open state. Therefore, while the temperature T4 is higher than the reference value Tr, the opening and closing valve 34d is maintained in the open state, and the hydrogen gas is continuously supplied from the hydrogen tank 20d to the hydrogen gas supply destination 4. While the hydrogen gas is being supplied from the hydrogen tank 20d to the hydrogen gas supply destination 4, the temperature of the hydrogen tank 20d gradually decreases. When the temperature T4 of the hydrogen tank 20d decreases to or below the reference value Tr (YES in S16), the control device 50 closes the opening and closing valve 34d in S18 and executes S2 again. That is, the control device 50 opens the opening and closing valve 34a and closes the opening and closing valves 34b, 34c, 34d. Therefore, the supply of the hydrogen gas from the hydrogen tank 20d to the hydrogen gas supply destination 4 is stopped, and the hydrogen gas is supplied from the hydrogen tank 20a to the hydrogen gas supply destination 4.

In the hydrogen gas supply operation, the control device 50 repeatedly executes S2 to S18. When the control device 50 receives the stop instruction of the hydrogen gas supply operation, the control device 50 closes the open state of the opening and closing valve 34 and sets the opening and closing valves 34a to 34d to the closed state.

When the hydrogen gas is continuously supplied to the hydrogen gas supply destination 4, the temperature of the hydrogen tank 20 decreases. When the temperature of the hydrogen tank 20 is excessively low (for example, −40° C. or lower), the deterioration of the component of the hydrogen tank 20 is likely to occur. In the present embodiment, when the temperature of the hydrogen tank 20 decreases to the reference value Tr or lower, the control device 50 closes the opening and closing valve 34 of the hydrogen tank 20 and opens one opening and closing valve 34 of the hydrogen tanks 20 in the closed state. As a result, the hydrogen gas can be continuously supplied to the hydrogen gas supply destination 4 without interruption while preventing further temperature decrease of the hydrogen tank 20 that is cooled to the reference value Tr or lower. In addition, the hydrogen tank 20 cooled to the reference value Tr or lower is heated by the outside air temperature to increase the temperature to a temperature higher than the reference value Tr. Therefore, it is possible to prevent the deterioration of the component of the hydrogen tank 20.

In the above-described embodiment, the control device 50 executes the hydrogen gas supply operation by opening one of the opening and closing valves 34 of the hydrogen tanks 20. However, the control device 50 may execute the hydrogen gas supply operation by putting all the opening and closing valves 34 of the hydrogen tank 20 in the open state when the temperature of the hydrogen tank 20 exceeds the reference value Tr. In this case, the control device 50 closes the hydrogen tank 20 in which the temperature has decreased to the reference value Tr or lower. Therefore, the hydrogen gas can be supplied from the hydrogen tank 20 having the temperature higher than the reference value Tr to the hydrogen gas supply destination 4.

In the above-described embodiment, the hydrogen gas storage device 10 has four hydrogen tanks 20. However, the hydrogen gas storage device 10 may have two or more hydrogen tanks 20.

Although the embodiments have been described in detail above, the above is merely an example and does not limit the scope of claims. The techniques described in the claims include various modifications and changes of the specific examples exemplified above. The technical elements described in the present specification or the drawings exhibit technical usefulness alone or in various combinations, and are not limited to the combinations described in the claims at the time of filing. Further, the techniques exemplified in the present specification or the drawings achieve a plurality of objectives at the same time, and achieving one of the objectives itself has technical usefulness.

What is claimed is:

1. A hydrogen gas storage device comprising:
a plurality of hydrogen tanks provided with opening and closing valves in discharge flow paths;
a hydrogen gas supply flow path connected to the hydrogen tanks through a plurality of the opening and closing valves, the hydrogen gas supply flow path being configured to supply hydrogen gas from the hydrogen tanks to an external hydrogen gas supply destination;
a plurality of temperature sensors configured to detect temperatures of the respective hydrogen tanks; and
a control device, wherein the control device is configured to, in a hydrogen gas supply operation of supplying hydrogen gas to the hydrogen gas supply destination, control each of the opening and closing valves such that
a hydrogen tank among the hydrogen tanks is opened, and
when a temperature of the hydrogen tank in an open state is equal to or lower than a reference value, the hydrogen tank of which the temperature is equal to or lower than the reference value is closed, and at least one of the hydrogen tanks in a closed state is opened.

2. The hydrogen gas storage device according to claim 1, wherein the control device is configured to, when the temperature of the hydrogen tank in the open state is equal to or lower than the reference value, open at least one hydrogen tank among the hydrogen tanks in the closed state, the at least one hydrogen tank having a temperature higher than the reference value.
